(19) United States
(12) Patent Application Publication
(10) Pub. No.: US 2013/0171974 A1
(43) Pub. Date: Jul. 4, 2013

(54) METHOD AND SYSTEM FOR PROVIDING ROAMING SERVICE BETWEEN CIRCUIT SWITCHED NETWORK AND INTERNET PROTOCOL MULTIMEDIA SUBSYSTEM NETWORK, AND APPARATUS THEREOF

(71) Applicant: Su-jin Bae, Suwon-si (KR)

(72) Inventor: Su-jin Bae, Suwon-si (KR)

(73) Assignee: SAMSUNG ELECTRONICS CO. LTD., Suwon-si, Gyeonggi-do (KR)

(21) Appl. No.: 13/824,055

(22) PCT Filed: Nov. 16, 2010
(86) PCT No.: PCT/KR10/08092

§ 371 Date: Mar. 15, 2013

(30) Foreign Application Priority Data
Oct. 15, 2010 (KR) 10-2010-0100967

(51) Int. Cl. H04W 8/04

(52) U.S. Cl. CPC H04W 8/04
USPC 455/411

(57) ABSTRACT

A method and system for providing roaming features between an Internet Protocol Multimedia Subsystem (IMS) and a Circuit Switched (CS) network, and an apparatus thereof are provided. Upon receiving an IMS registration request from a roaming MS having roamed to the IMS network, a Roaming Gateway (RGW) performing communication between the IMS network and the CS network sends a request for registration and authentication for the roaming MS to a Home Location Register (HLR) in the CS network. The RGW acquires profile information for the roaming MS in the CS network from the HLR, and delivers the profile information of the roaming MS to an IMS server in the IMS network. The IMS server delivers authentication results to the roaming MS.

### TECHNICAL FIELD

The present invention relates generally to a method and system for providing roaming features between an Internet Protocol Multimedia Subsystem (IMS) operator network based on a packet access network (Mobile Worldwide Interoperability for Microwave Access (WiMAX), Wideband Code Division Multiple Access (WCDMA) High Speed Download Packet Access (HSDPA), CDMA Evolution-Data Only (1xEv-DO), Long Term Evolution (LTE), etc.) and a 2G/3G Circuit Switched (CS) operator network, and an apparatus thereof, and more particularly, to a method and system in which, having been receiving a service in a CS-based voice network, a subscriber roams to an IMS network of another operator with which the subscriber has made a roaming agreement, and receives the same voice service in the IMS network, and an apparatus thereof.

### BACKGROUND ART

A roaming service in the existing communication network provides voice services through roaming between operators using the same access technology (e.g., between a Korean 3G network operator and a Japanese 3G network operator, or between Global System for Mobile communication (GSM) operators in Europe), or between CS network operators using different access technologies (e.g., between GSM and WCDMA operators, or between CDMA and WCDMA operators), and additional services between roaming networks are provided according to the interfaces defined in the standards.

The existing roaming service provides roaming features only between operators supporting the same technology or between CS network operators as described above, and network architecture for providing a roaming service between an IP-based IMS operator and the existing CS operator and a service provision method thereof have not yet been defined.

### DISCLOSURE OF INVENTION

### Technical Problem

However, with the evolution of networks into IP-based networks and the introduction of IP-based IMS voice services, there are increasing demands for providing voice roaming services between an IMS operator and the existing CS operator.

### Solution to Problem

An aspect of the present invention is to address at least the above-mentioned problems and/or disadvantages and to provide at least the advantages described below. Accordingly, an aspect of exemplary embodiments of the present invention is to provide a method and system for providing a roaming service in a wireless communication system, and an apparatus thereof.

Another aspect of exemplary embodiments of the present invention is to provide a method and system in which, having roamed from a CS network to an IMS network, a Mobile Station (MS) may receive the voice services it has been receiving in the CS network, even in the IMS network, and an apparatus thereof.

Another aspect of exemplary embodiments of the present invention is to provide a method and system in which, having roamed from a CS network to an IMS network, an MS may receive the services it has been receiving in the CS network, even in the IMS network, and an apparatus thereof.

Another aspect of exemplary embodiments of the present invention is to provide a method and system for providing a variety of additional services by expanding a roaming agreement between a CS network operator and an IMS network operator, and an apparatus thereof.

Another aspect of exemplary embodiments of the present invention is to provide a method and system for enabling the existing 2G/3G CS subscriber to perform inbound roaming to an IMS network, and an apparatus thereof.

Another aspect of exemplary embodiments of the present invention is to provide a method and system for allowing even the existing CS network subscriber to use the cheap voice service in an IMS network to which the subscriber has roamed, using a Voice over IP (VoIP) service of the IMS network, and an apparatus thereof.

Another aspect of exemplary embodiments of the present invention is to provide a method and system for offering an opportunity to expand business between an IMS network operator and a CS network operator, and enabling the IMS operator to increase the number of its subscribers, and an apparatus thereof.

In accordance with one aspect of the present invention, a method is provided for providing a roaming service to a roaming Mobile Station (MS) having roamed from a Circuit Switched (CS) network to an Internet Protocol Multimedia Subsystem (IMS) network. The method includes, upon receiving an IMS registration request from the roaming MS having roamed to the IMS network, sending a request for registration and authentication for the roaming MS to a Home Location Register (HLR) in the CS network by a Roaming Gateway (RGW) performing communication between the IMS network and the CS network; acquiring profile information about the roaming MS in the CS network from the HLR; delivering the profile information of the roaming MS to an IMS server in the IMS network; and delivering by the IMS server authentication results to the roaming MS.

In accordance with another aspect of the present invention, a system is provided for providing a roaming service to a roaming Mobile Station (MS) having roamed from a Circuit Switched (CS) network to an Internet Protocol Multimedia Subsystem (IMS) network. The system includes a Roaming Gateway (RGW) for performing communication between the IMS network and the CS network, sending a request for registration and authentication for the roaming MS to a Home Location Register (HLR) in the CS network upon receipt of an IMS registration request from the roaming MS having roamed to the IMS network, acquiring profile information for the roaming MS in the CS network from the HLR, and transmitting the acquired profile information of the roaming MS; and an IMS server for receiving the profile information from the RGW, and delivering authentication results to the roaming MS.

In accordance with another aspect of the present invention, an apparatus is provided for providing a roaming service to a roaming Mobile Station (MS) having roamed from a Circuit Switched (CS) network to an Internet Protocol Multimedia Subsystem (IMS) network. The apparatus includes a Home Subscriber Server (HSS)-for-roaming user for sending a request to acquire information about the roaming MS in the CS network upon receiving an IMS registration request from the roaming MS having roamed to the IMS network, and performing authentication on the roaming MS upon acquiring information about the roaming MS in the CS network; and a visited Mobile Service Center (MSC) for sending a request for registration and authentication for the roaming MS to a Home Location Register (HLR) in the CS network upon receiving from the HSS-for-roaming user a request to acquire information about the roaming MS in the CS network, acquiring service profile information for the roaming MS, and delivering the acquired service profile information to the HSS-for-roaming user.

### Advantageous Effects of Invention

As is apparent from the foregoing description, when voice services are provided in an extended manner by making a roaming agreement between an IMS operator and a CS operator, which are geographically separated, a subscriber to the existing CS network may roam to an IMS network of another operator and receive the voice services at cheaper prices compared with those in the CS network, thereby offering differentiated features for attracting subscribers to the operator seeking to expand the business area between different operators, and to introduce initial IMS.

For example, according to the present invention, a subscriber to a Korean WCDMA CS network may receive a voice service over a Japanese IMS operator network, while on a business trip to Japan, and may also receive a voice service of a Korean WCDMA network, which is a home network of the subscriber.

### BRIEF DESCRIPTION OF DRAWINGS

The above and other aspects, features and advantages of certain exemplary embodiments of the present invention will be more apparent from the following description taken in conjunction with the accompanying drawings, in which:

FIG. 1 is a diagram illustrating network architecture for providing services to a user having roamed from a CS network to an IMS network according to an embodiment of the present invention;

FIG. 2 is a signal flow diagram illustrating a registration procedure in a case where, having been receiving a service in a CS network, an MS roams to an IMS network, according to an embodiment of the present invention;

FIGS. 3 and 4 are diagrams illustrating a signal flow in a case where, having roamed from a CS network to an IMS network, an MS sends a call, according to an embodiment of the present invention;

FIG. 5 is a diagram illustrating a signal flow in a case where a call terminates at an MS A having roamed from a CS network to an IMS network, according to an embodiment of the present invention;

FIG. 6 is a diagram illustrating a signal flow in a case where, having roamed from a CS network to an IMS network, an MS A sends an SMS message, according to an embodiment of the present invention;

FIG. 7 is a diagram illustrating a signal flow in a case where, having roamed from a CS network to an IMS network, an MS A sends an SMS message, according to another embodiment of the present invention;

FIG. 8 is a diagram showing a signal flow in a case where an SMS message terminates at an MS A having roamed from a CS network to an IMS network, according to an embodiment of the present invention; and

FIG. 9 is a diagram showing a signal flow in a case where an SMS message terminates at an MS A having roamed from a CS network to an IMS network, according to another embodiment of the present invention.

Throughout the drawings, the same drawing reference numerals will be understood to refer to the same elements, features and structures.

### MODE FOR THE INVENTION

Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

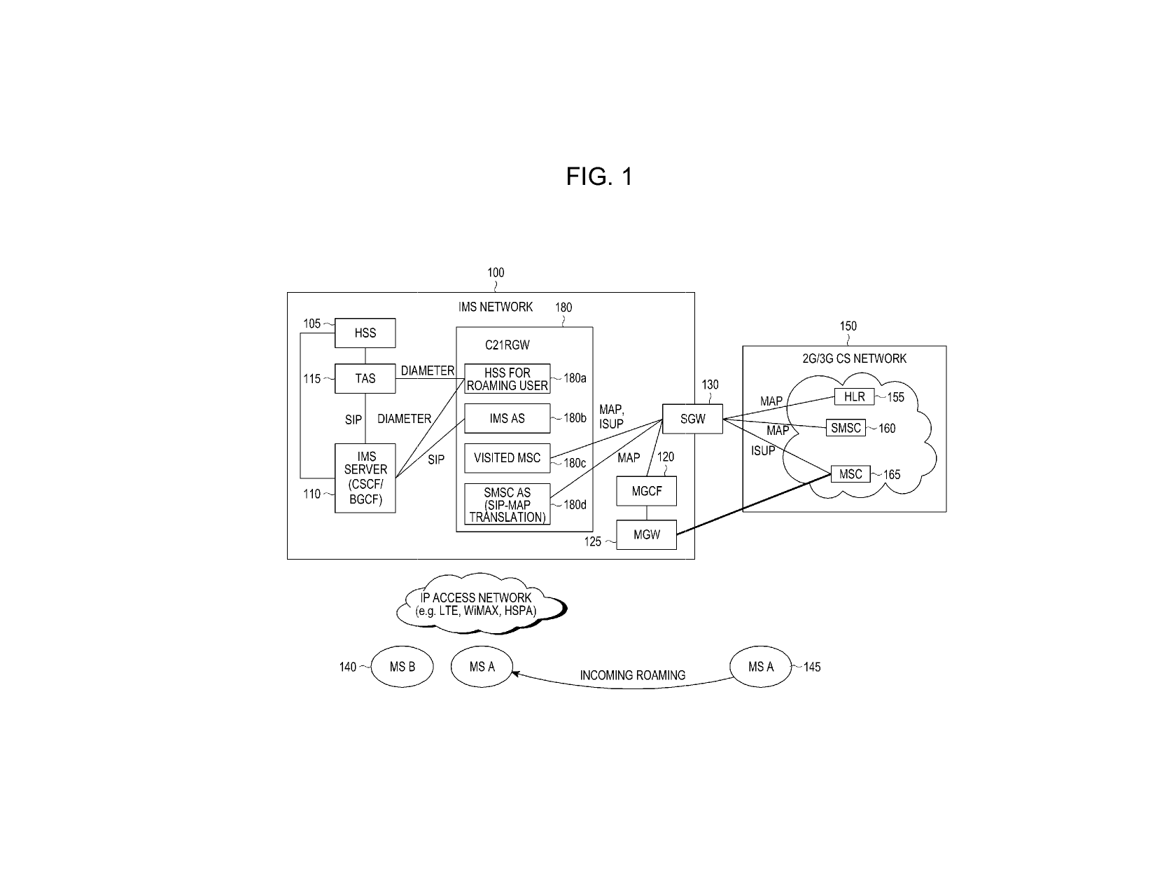

FIG. 1 illustrates network architecture for providing services to a user having roamed from a CS network to an IMS network according to an embodiment of the present invention.

Referring to FIG. 1, the network according to the present invention includes an IMS network 100 and a 2G/3G CS network 150. An MS A 145 according to the present invention may roam from the CS network 150 to the IMS network 100. In this specification, it is assumed that the MS A 145 has roamed from the CS network 150 to the IMS network 100. Therefore, in this specification, the terms ‘MS A’ and ‘roaming MS A’ will be used in the same meaning. The MS A 145 may support both a packet access network service mode of the IMS network 100 and a voice service mode of the CS network 150. For example, an IMS client may be implemented in the MS A 145 so that the MS A 145, which has been receiving a service in the CS network 150, may receive the service even in the IMS network 100.

The IMS network 100 roughly includes an IMS server 110 for controlling sessions for subscribers in the IMS network 100, a Home Subscriber Server (HSS) 105 for storing subscriber profiles of the IMS network 100, a Telephony Application Server (TAS) 115, which is a group of Application Servers (ASs) providing additional services, a Media Gateway Control Function (MGCF) 120 for offering signaling conversion for interworking between the IMS network 100 and the CS network 150, a Media Gateway (MGW) 125 for handling media conversion between the CS network 150 and the MGCF 120, and a CS to IMS Roaming Gateway (C2I RGW) 180, which is a CS to IMS roaming gateway newly defined according to the present invention.

To be specific, if an MS B 140 is located in the IMS network 100, the IMS server 110 performs call processing and service processing for the MS B 140. The IMS server 110 performs the call and service processing by receiving a profile of the MS B 140 from the HSS 105, and interworks with the TAS 115 and the C2I RGW 180 for service provision. The IMS server 110 performs Call Session Control Function (CSCF) and Breakout Gateway Control Function (BGCF) in the IMS network 100, which are defined in the 3rd Generation Partnership Project (3GPP) standard.

The MGCF 120 is a gateway enabling exchange of voice signals between the IMS network 100 and the CS network 150. That is, the MGCF 120 serves as a route for voice signals exchanged between the IMS network 100 and the CS network 150.

The HSS 105 stores and manages profiles of subscribers in the IMS network 100. The HSS 105 manages profiles of subscribers separately according to whether they are roaming subscribers or non-roaming subscribers.

The TAS 115 provides various additional services to subscribers to the IMS network 100, and stores and manages subscriber-specific service information. Services provided by the TAS 115 may include the additional services which have been used conventionally in the CS network 150. For example, the services provided by the TAS 115 may include call hold, call forwarding, call transfer, call restriction, calling line identification presentation/restriction, and call holding/call waiting services.

A Signaling Gateway (SGW) 130 is adapted to deliver signaling between the IM S network 100 and the CS network 150, which use different signalings.

The C2I RGW 180, a network component newly defined according to an embodiment of the present invention, will now be described.

The C2I RGW 180 (hereinafter simply referred to as a ‘Roaming Gateway (RGW)’) performs protocol translation and interworking processing between the IMS network 100 and the CS network 150 to provide roaming features between the IMS network 100 and the CS network 150 according to an embodiment of the present invention. For example, the RGW 180 translates the protocol in use into 3G Mobile Application Part (MAP) if the CS network 150 is a 3G WCDMA network; translates the protocol in use into Interim Standard-41 (IS-41) MAP if the CS network 150 is a CDMA network; and translates the protocol in use into GSM MAP if the CS network 150 is a GSM network. That is, the RGW 180 processes MAP protocols, e.g., IS-41 MAP, 3G GSM MAP, and 3G MAP protocols, for interworking with a Mobile Service Center (MSC) 165, a Home Location Register (HLR) 155 and a Short Message Service Center (SMSC) 160 in the CS network 150.

The RGW 180 performs roaming processing between two networks to provide inbound roaming from the CS network 150 to the IMS network 100.

The RGW 180 according to an embodiment of the present invention includes an HSS-for-roaming user 180a, an IMA Application Server (AS) 180b, a visited MSC 180c, and an SMSC AS 180d.

The HSS-for-roaming user 180a manages information about a subscriber of the MS A 145 having roamed from the CS network 150 to the IMS network 100, and provides roaming information about the roaming subscriber upon request for registration in the IMS network 100 from the MS A 145 having roamed to the IMS network 100.

The visited MSC 180c performs authentication/registration and call processing for the MS A 145, which is a subscriber to the CS network 150, having roamed to the IMS network 100, and if the subscriber to the CS network 150, having roamed to the IMS network 100, requests its registration in the IMS network 100, the visited MSC 180c performs functions of a Visit Location Register (VLR) and a visited MSC, for the HLR 155 in the CS network 150. That is, the visited MSC 180c serves as a VLR, for a 2G/3G user having roamed to the IMS network 100. To process a terminating call for the roaming MS A 145, the visited MSC 180c manages and provides AS triggering information to the RGW 180 and Short Message Service (SMS) triggering information for SMS sending, as profile information of the roaming MS A 145. If a call terminates at the MS A 145 having roamed to the IMS network 100, the visited MSC 180c generates and manages a roaming number MSRN to be used. The RGW 180 provides the generated roaming number to the HLR 155 in the CS network 150 as a roaming number for the roaming MS A 145.

If a call terminates from the CS network 150 with a roaming number assigned to the roaming MS A 145, the visited MSC 180c extracts and provides an IMS terminating ID corresponding to the roaming number.

The IMS AS 180b serves as an AS, for the IMS server 110 in the IMS network 100.

If a subscriber having roamed from the CS network 150 to the IMS network 100 sends an SMS message, the SMSC AS 180d serves as an SMSC handling the SMS message, and serves as a gateway for translating an IMS Session Initiation Protocol (SIP) and a 2G/3G MAP protocol.

Network components in the CS network 150 will now be described. The 2G/3G CS network 150 includes the MSC 165 in charge of call processing and subscriber processing, the HLR 155 storing subscriber profiles of the 2G/3G CS network 150, and the SMSC 160 for processing SMS messages.

The MSC 165 performs call processing and service interworking for the MS which will receive a service in the 2G or 3G network, downloads a profile of the MS from the HLR 155, and performs call processing and service processing using the downloaded profile.

The HLR 155 stores a profile of an MS subscribed to the CS network 150, stores the type and service interworking information of the service provided to an individual MS subscribed to the CS network 150, and provides the stored information to the MSC 165.

The MSs 140 and 145 may subscribe to an IMS network based on a packet access network (e.g., Mobile WiMAX, WCDMA HSDPA, CDMA 1xEv-DO, and LTE) and provide a VoIP service. The MS A 145 represents a terminal having roamed from the 2G/3G CS network 150 to the IMS network 100, while the MS B 140 represents a terminal accessing the IMS network 100 and receiving a service therefrom. To support roaming from the CS network 150 to the IMS network 100, the MSs according to the present invention may support both a packet access network mode and a CS network mode (i.e., dual-mode phones), or may support only a packet access network mode (i.e., single-mode phones with only IMS client equipped, e.g., rental phones).

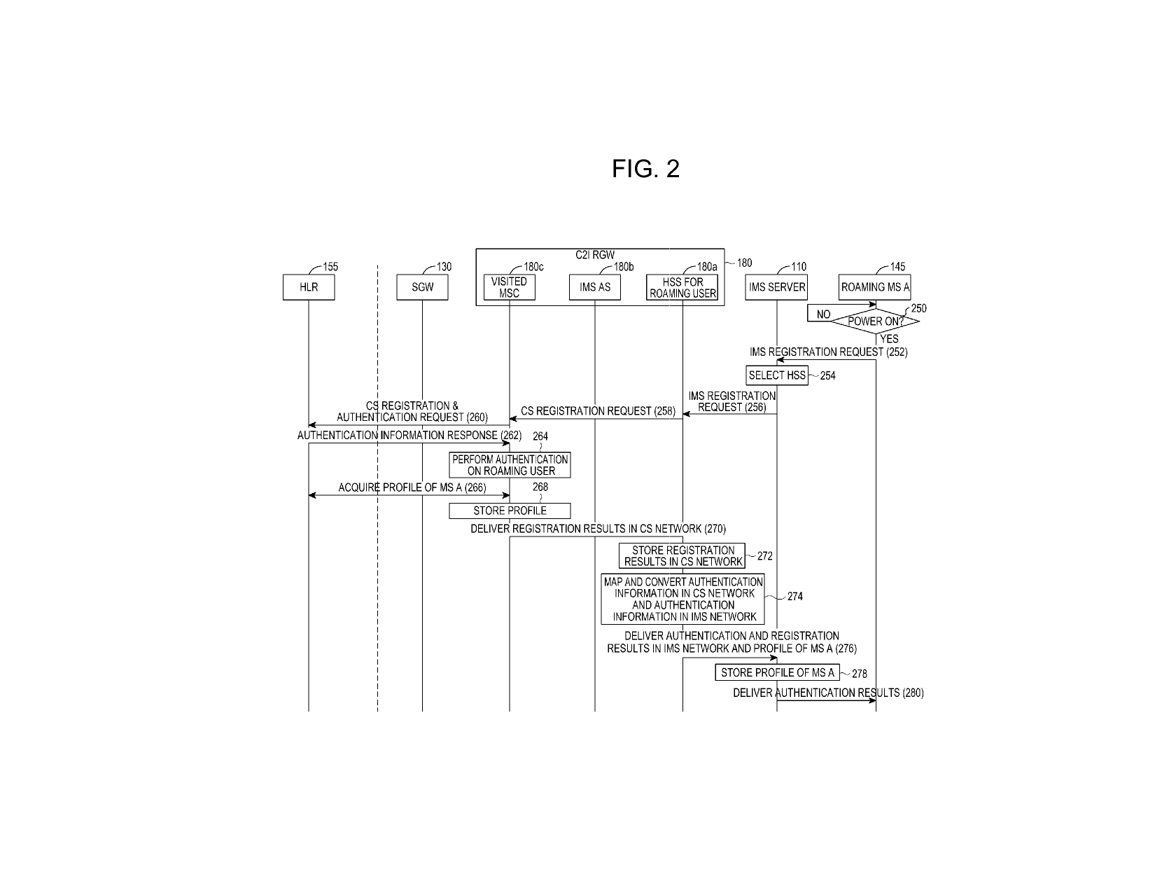

FIG. 2 illustrates a registration procedure in a case where, having been receiving a service in a CS network, an MS roams to an IMS network, according to an embodiment of the present invention.

In this specification, the MS A 145 means an MS having roamed from the CS network to the IMS network.

If the MS A 145 is powered on in the IMS network in step 250 after having roamed to the IMS network, the MS A 145 sends an IMS registration request to the IMS server 110 in step 252. The IMS server 110 selects the HSS-for-roaming user 180a for handling registration of the MS A 145 in the RGW 180 in step 254, and sends an IMS registration request for the MS A 145 to the HSS-for-roaming user 180a in step 256. For example, the IMS server 110 selects a separate HSS for each IMS subscriber in step 254, and all unique numbers of MSs having roamed may be selected to be linked to the HSS-for-roaming user 180a. Upon receiving the IMS registration request for the MS A 145 in step 256, the HSS-for-roaming user 180a sends a CS registration request to the visited MSC 180c in step 258. In step 260, the visited MSC 180c sends a CS registration & authentication request to the HLR 155 in the 2G/3G CS network 150, which is a home network of the MS A 145. The visited MSC 180c receives an authentication information response for the MS A 145 from the HLR 155 in the 2G/3G CS network 150 in step 262, and performs authentication on the MS A 145 in step 264.

After success in the authentication in the CS network, the visited MSC 180c acquires a profile of the MS A 145 from the HLR 155 in step 266, and stores the acquired profile in step 268.

The visited MSC 180c transmits the results on registration performed in the CS network to the HSS-for-roaming user 180a in step 270, and the HSS-for-roaming user 180a stores the results on registration performed in the CS network in step 272. In step 274, the HSS-for-roaming user 180a maps authentication information in the CS network to authentication information in the IMS network and performs conversion on the information. In step 276, the HSS-for-roaming user 180a delivers the authentication and registration results in the IMS network and profile information of the MS A 145 to the IMS server 110. At this time, in step 274, the HSS-for-roaming user 180a maps additional service information in the CS network for the MS A 145, received from the HLR 155, to additional service information provided in the IMS network. For example, the HSS-for-roaming user 180a maps additional services in the CS network to an address of the TAS capable of providing in the IMS network the additional services in the CS network, or assigns subscriber information to the TAS.

In step 274, the HSS-for-roaming user 180a maps an International Mobile Station Identity (IMSI) and a Mobile Station International IDSN Number (MSISDN) of the MS A 145 in the CS network to a Public User Identity and a Private User Identity of the MS A 145 in the IMS network. The HSS-for-roaming user 180a maps an ID of the MS A 145 in the CS network to an ID of the MS A 145 having roamed to the IMS network.

In step 276, the HSS-for-roaming user 180a responds with the authentication and registration processing results to the IMS network according to the authentication information for the MS A 145, received from the HLR 155. For this response, the HSS-for-roaming user 180a may generate an authentication key or an authentication response message and send it to the IMS server 110. Specifically, describing how the HSS-for-roaming user 180a transmits authentication and registration information and profile information for the MS A 145 in the IMS network to the IMS server 110 in step 276, the HSS-for-roaming user 180a also includes an operation of translating the service profile of the MS A 145, received from the HLR 155, into protocol and data for its transmission to the IMS network. For example, the HSS-for-roaming user 180a translates the service profile of the MS A 145, received from the HLR 155, into a Diameter protocol and an eXtensible Markup Language (XML) and transmits them.

In step 278, the IMS server 110 performs IMS authentication on the MS A 145, and stores the profile of the MS A 145 if it succeeds in the registration. In step 280, the IMS server 110 delivers the authentication results to the MS A 145. The signal flow illustrated in FIG. 2 is subject to change depending on its implementation.

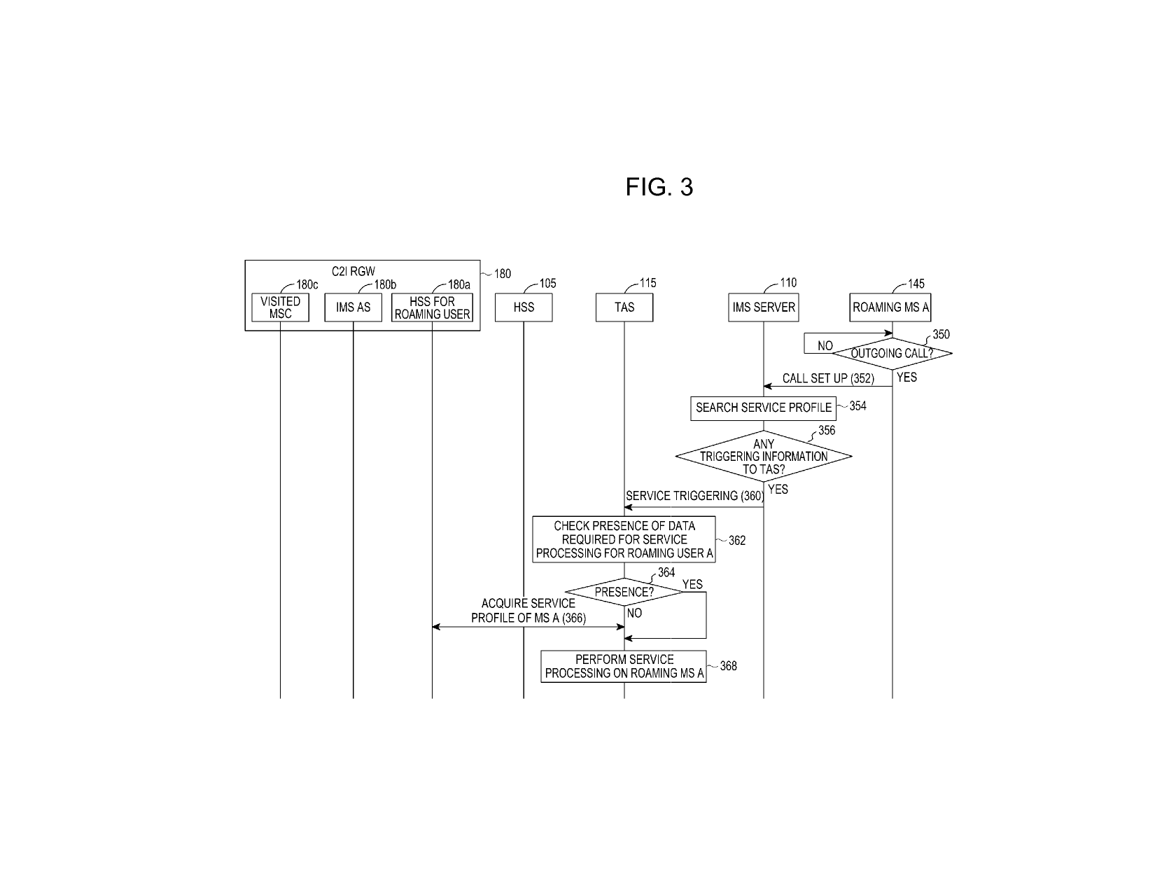

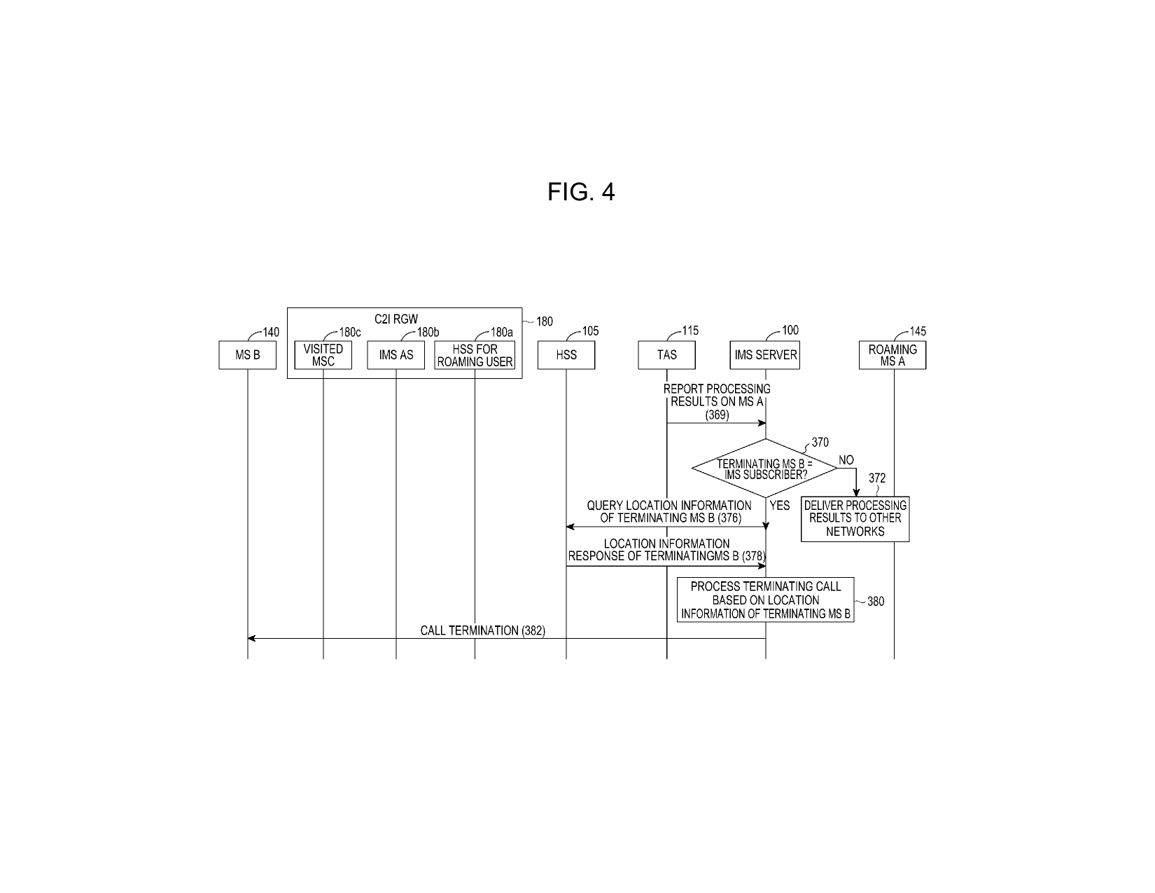

FIGS. 3 and 4 illustrate a signal flow in a case where, having roamed from a CS network to an IMS network, an MS sends a call, according to an embodiment of the present invention. FIGS. 3 and 4 are separated from a single drawing, for convenience of description.

It is assumed in FIGS. 3 and 4 that a call sent by the MS A 145 having roamed from the CS network to the IMS network terminates at the MS B 140 having accessed the same IMS network. If the MS A 145 having roamed to the IMS network sends or originates a call in step 350, the MS A 145 sends a call setup message to the IMS server 110 in step 352. In step 354, the IMS server 110 receives the call setup message and searches a service profile of the MS A 145 having sent the call setup message.

In step 356, the IMS server 110 determines whether there is triggering information to the TAS 115 in the profile information of the MS A 145, and if so, the IMS server 110 performs serving triggering to the TAS 115 in step 360. It is assumed in this specification that the MS A 145 having roamed to the IMS network has service triggering information to the TAS 115 for additional services. In step 362, the TAS 115 determines the presence/absence of data required for service processing for the MS A 145. In the presence of the data required for service processing for the MS A 145 in step 364, the TAS 115 performs service processing on the MS A 145 in step 368, whereas in the absence of the data required for service processing for the MS A 145 in step 364, the TAS 115 acquires a service profile of the MS A 145 from the HSS-for-roaming user 180a in association with the HSS-for-roaming user 180a in step 366, and then performs service processing on the MS A 145 using the acquired service profile in step 368. In step 369, the TAS 115 delivers the processing results on the MS A 145 to the IMS server 110.

In step 370, the IMD server 110 checks whether the terminating MS B 140 is an IMS network subscriber. If not so, the IMS server 110 delivers the processing results to another network, to which the MS B 140 belongs, in step 372. If it is checked in step 370 that the terminating MS B 140 is an IMS subscriber, the IMS server 110 queries the HSS 105 about location information of the terminating MS B 140 in step 376, and receives a location information response of the terminating MS B 140 from the HSS 105 in step 378. The IMS server 110 processes a terminating call (or an incoming call) according to the location information of the terminating MS B 140, received from the HSS 105, in step 380, and makes the call sent by the MS B 145 terminate at the terminating MS B 140 in step 382. Processing a terminating call in step 380 includes a series of steps of processing a service by triggering to the TAS 115 or another AS, and sending the call to the terminating MS B 140.

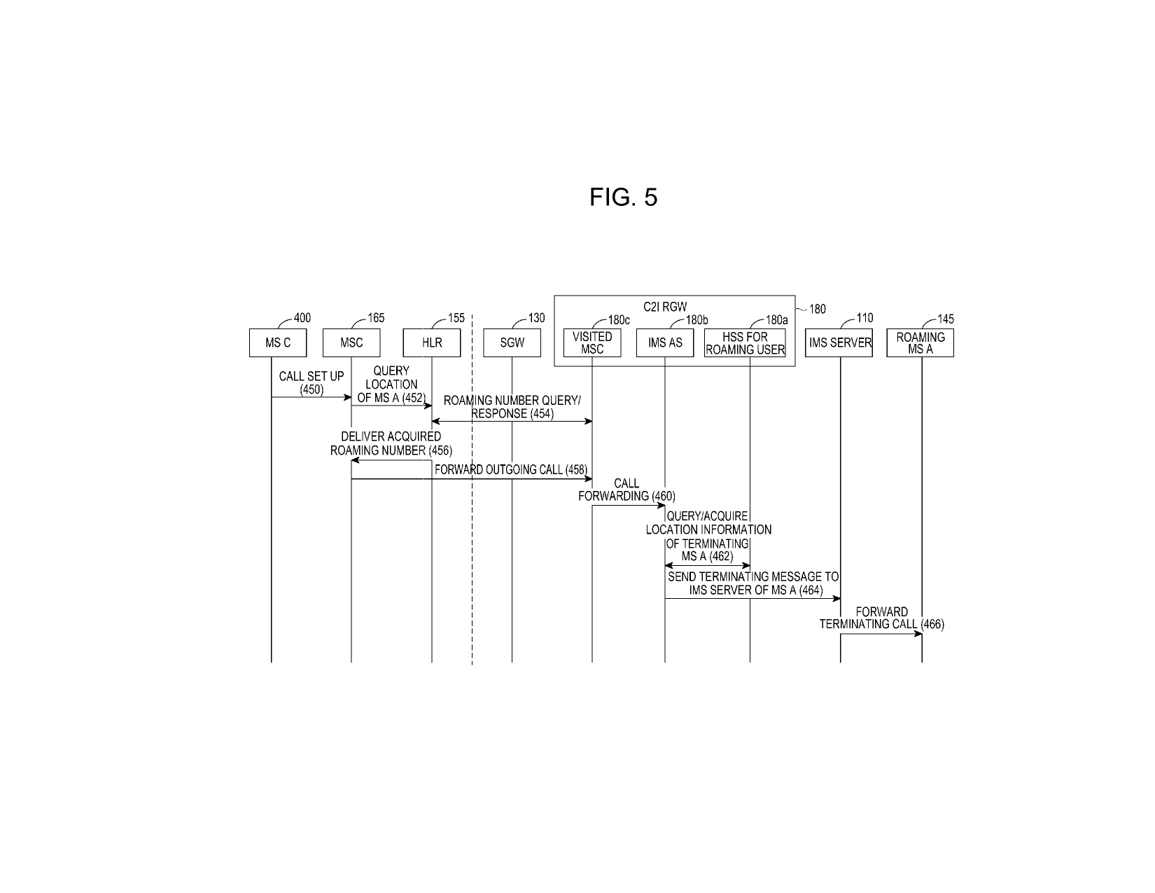

FIG. 5 illustrates a signal flow in a case where a call terminates at an MS A having roamed from a CS network to an IMS network, according to an embodiment of the present invention. In the example of FIG. 5, another MS C 400 in the CS network has originated a call (or has sent an outgoing call).

In step 450, the MS C 400 having accessed the 2G/3G CS network sends a call setup message to the MSC 165 to attempt an outgoing call to the MS A 145 having roamed to the IMS network.

In step 452, the MSC 165 in the CS network queries the HLR 155 in the CS network about a location of the terminating MS A 145, since the terminating MS A 145 is an MS belonging to the CS network.

In step 454, the HLR 155 queries the visited MSC 180c in the C2I RGW 180 in the IMS network in which the MS A 145 having roamed to the IMS network attempted its location registration, about a roaming number of the MS A 145, and the visited MSC 180c responds to the HLR 155 with a roaming number of the MS A 145 having roamed to the IMS network. The visited MSC 180c may generate and manage roaming numbers for the MSs having roamed to the IMS network. In step 456, the HLR 155 forwards the roaming number for the MS A 145, acquired in step 454, to the MSC 165.

In step 458, the MSC 165 forwards the outgoing call from the MS C 400 to the visited MSC 180c according to the roaming number received in step 456 from the HLR 155.

Upon receiving the call sent by the MS C 400, the visited MSC 180c forwards the call to the IMS AS 180b in step 460, and to process a call to terminate at the MS A 145, the IMS AS 180b acquires location information of the MS A 145 by querying the HSS-for-roaming user 180a about a location of the MS A 145 in step 462. To process the call to terminate at the MS A 145, the IMS AS 180b forwards the call to the IMS server 110, in which the MS A 145 is presently registered, in step 464.

In step 466, the IMS server 110 forwards the terminating call received in step 464, to the MS A 145.

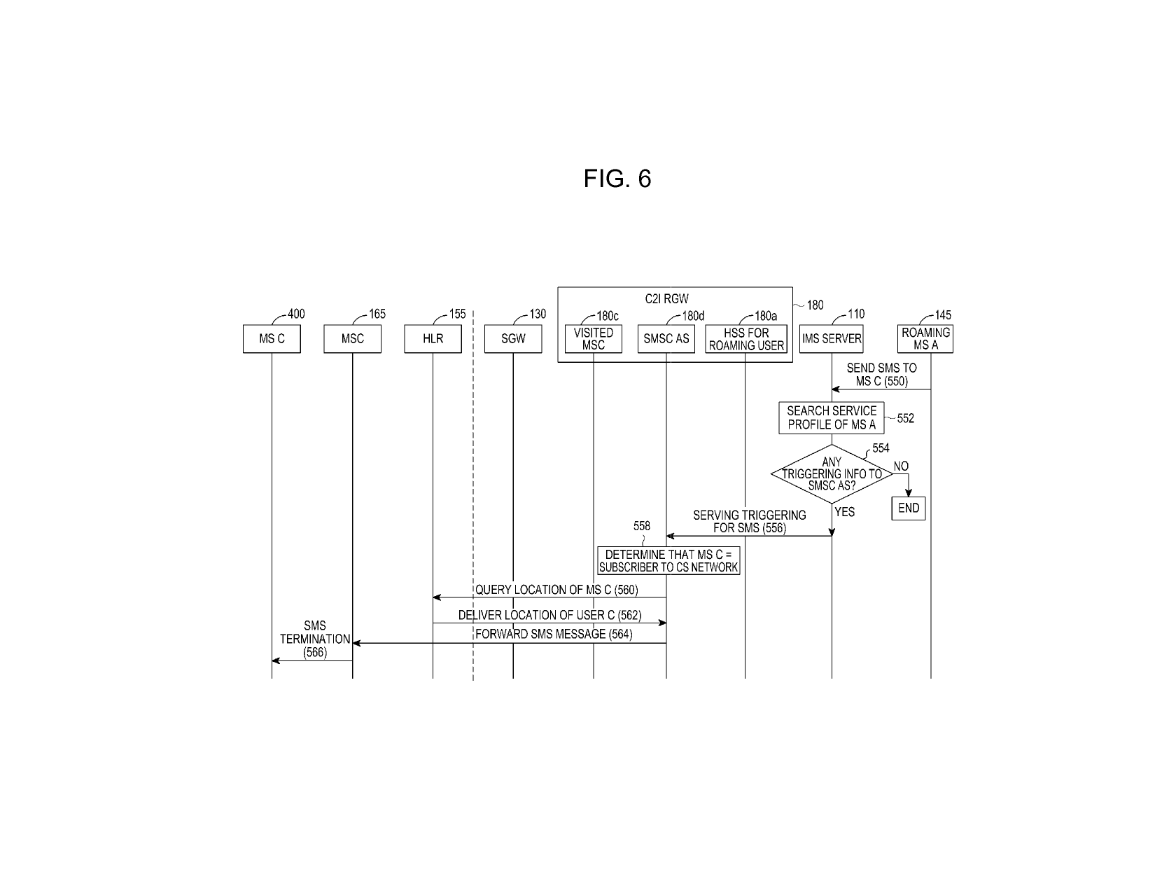

FIG. 6 illustrates a signal flow in a case where, having roamed from a CS network to an IMS network, an MS A sends an SMS message, according to an embodiment of the present invention. In the example of FIG. 6, the MS A 145 having roamed to the IMS network sends an SMS message to the MS C 400 located in the GSM/WCDMA-based CS network.

The MS A 145 forwards the SMS message to the IMS server 110 in step 550, and the IMS server 110 searches a stored service profile of the MS A 145 in step 552.

In step 554, the IMS server 110 determines the presence/absence of triggering information to an Application Server (AS) in the profile of the MS A 145. Here, the AS refers to the SMSC AS 180d, which is an AS handling SMS messages, since an SMS sending-related service should be provided. In the presence of the triggering information to the SMSC AS 180d in step 554, the IMS server 110 forwards the service triggering for SMS service to the SMSC AS 180d in step 556. In an embodiment of the present invention, it is assumed that for SMS sending, the MS A 145 has service triggering information to the SMSC AS 180d in the RGW 180.

The SMSC AS 180d identifies in step 558 that a phone number of the MS C 400, a terminating MS, is a phone number of a subscriber to the CS network, and then queries the HLR 155 located in the home network of the terminating MS C 400, about a location of the MS C 400 in step 560. The SMSC AS 180d acquires in step 562 the location information of the MS C 400, queried in step 560, and forwards the SMS message to the acquired location information (e.g., an address of the MSC 165) of the MS C 400, in step 564. In step 566, the MSC 165 forwards the SMS message received in step 564 to the MS C 400.

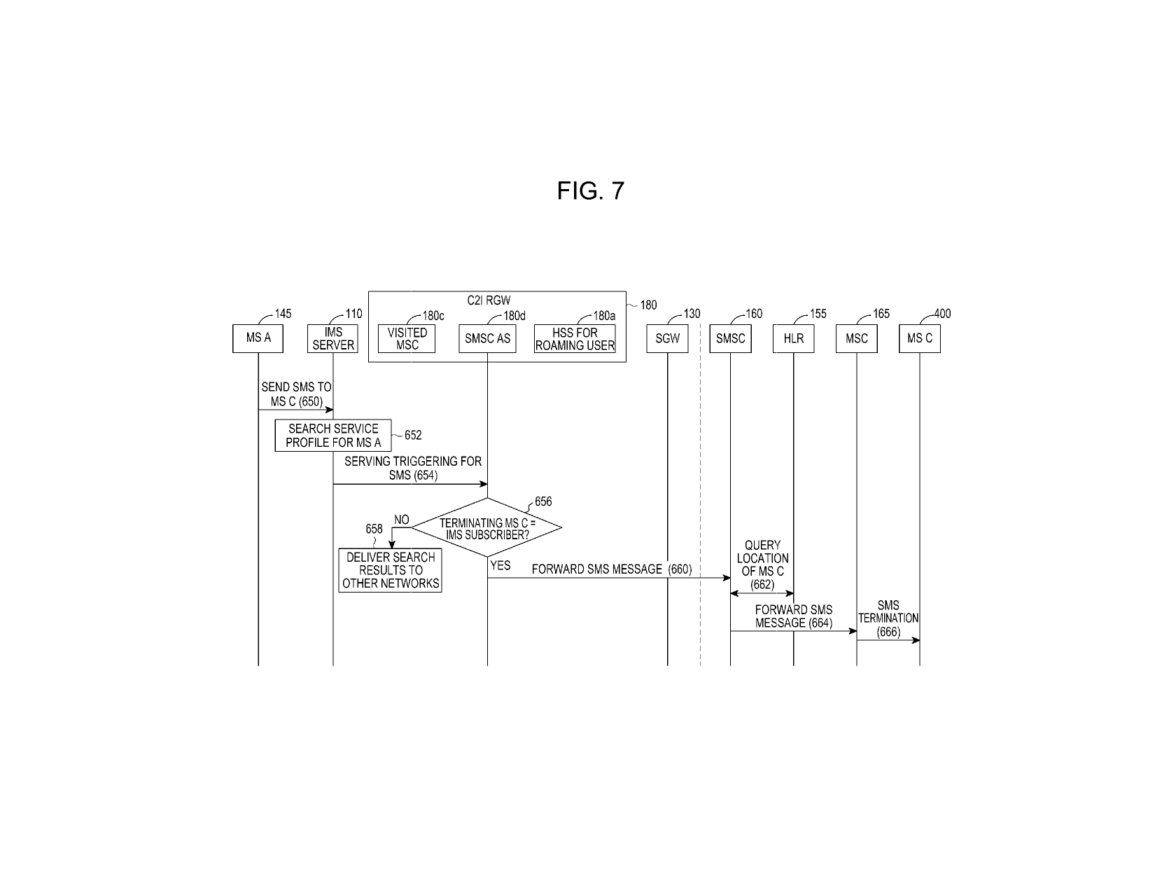

FIG. 7 illustrates a signal flow in a case where, having roamed from a CS network to an IMS network, an MS A sends an SMS message, according to another embodiment of the present invention. In the example of FIG. 7, the MS A 145 having roamed to the IMS network sends an SMS message to the MS C 400 located in the CDMA-based CS network.

If the MS A 145 having roamed to the IMS network sends the IMS server 110 the SMS message to be delivered to the MS C 400 located in the CDMA-based CS network in step 650, the IMS server 110 searches a pre-stored service profile of the MS A 145 in step 652. The IMS server 110 may store service profile information of the MS A 145 in accordance with the registration procedure, which is performed on the IMS network when the MS A 145 roams from the CS network to the IMS network.

Upon identifying the presence of triggering information to the SMSC AS 180d in the service profile of the MS A 145 as a result of searching the service profile information of the MS A 145 in step 652, the IMS server 110 performs service triggering to the SMSC AS 180d in step 654. It is assumed in FIG. 7 that for SMS sending, the MS A 145 has service triggering information to the SMSC AS 180d in the RGW 180.

In step 656, the SMSC AS 180d determines whether the terminating MS C 400 is a CDMA network subscriber, and if not so, forwards the SMS message received from the MS A 145 to another network in step 658. On the other hand, if the terminating MS C 400 is a CDMA network subscriber in step 656, the SMSC AS 180d forwards the SMS message received in step 654 to the SMSC 160 located in the home network of the MS C 400 in step 660, determining that the terminating MS C 400 is an MS subscribed to the CDMA network.

In step 662, the SMSC 160 queries the HLR 155 about location information of the terminating MS C 400, and acquires the queried location information. In step 664, the SMSC 160 forwards the SMS message to the MSC 165 according to the location information of the terminating MS C 400, received from the HLR 155. In step 666, the MSC 165 sends the received SMS message to the MS C 400, or a terminating MS.

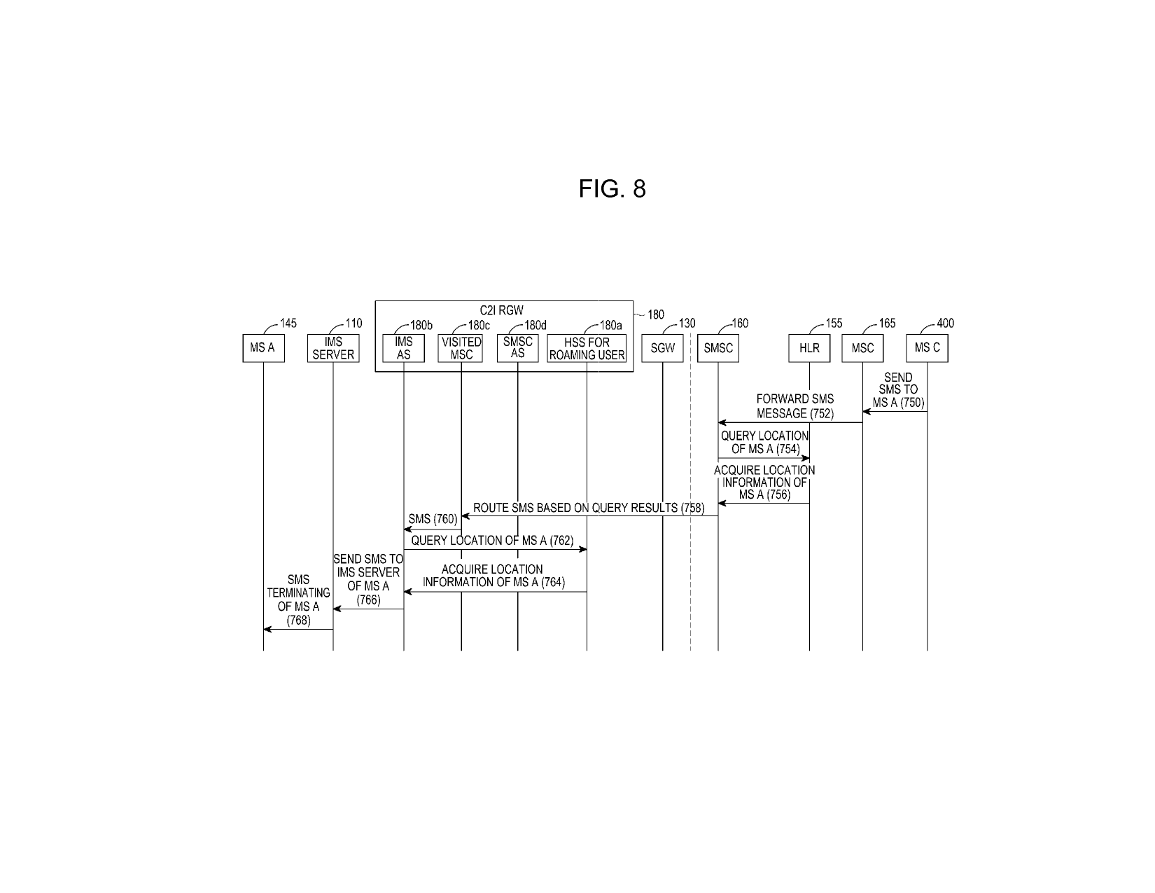

FIG. 8 illustrates a signal flow in a case where an SMS message terminates at an MS A having roamed from a CS network to an IMS network, according to an embodiment of the present invention. In the example of FIG. 8, the MS C 400 in the GSM/WCDMA-based CS network sends an SMS message to the MS A 145 having roamed to the IMS network.

In step 750, the MS C 400 sends the SMC 150 an SMS message to be transmitted to the MS A 145 having roamed to the IMS network. In step 752, the MSC 165 forwards the SMS message received in step 750 to the SMSC 160 of the MS C 400, an originating subscriber. Here, the SMSC 160 in the CS network is an SMSC of the MS C 400 having sent the SMS message. In step 754, the SMSC 160 queries the HLR 155 located in the home network of the MS A 145, about location information of the MS A 145, determining that the MS A 145, at which the SMS message is to terminate, is a subscriber that has belonged to the CS network before roaming to the IMS network. In step 756, the SMSC 160 acquires location information of the MS A 145 from the HLR 155. Here, the HLR 155 is an HLR of the MS A 145, or a terminating subscriber.

In step 758, the SMSC 160 forwards the SMS message received in step 752 to the visited MSC 180c in the RGW 180 according to the location information of the MS A 145, received from the HLR 155. In step 760, the visited MSC 180c forwards the SMS message received in step 758 to the IMS AS 180b. To forward the SMS message to the MS A 145, the IMS AS 180b queries the HSS-for-roaming user 180a about location information of the MS A 145 in step 762, and acquires the location information of the MS A 145 from the HSS-for-roaming user 180a in step 764. In step 766, the IMS AS 180b sends the SMS message received in step 760 to the IMS server 110 in which the MS A 145 is presently registered, using the location information of the MS A 145, acquired in step 764. In step 768, the IMS server 110 forwards the received SMS message to the MS A 145.

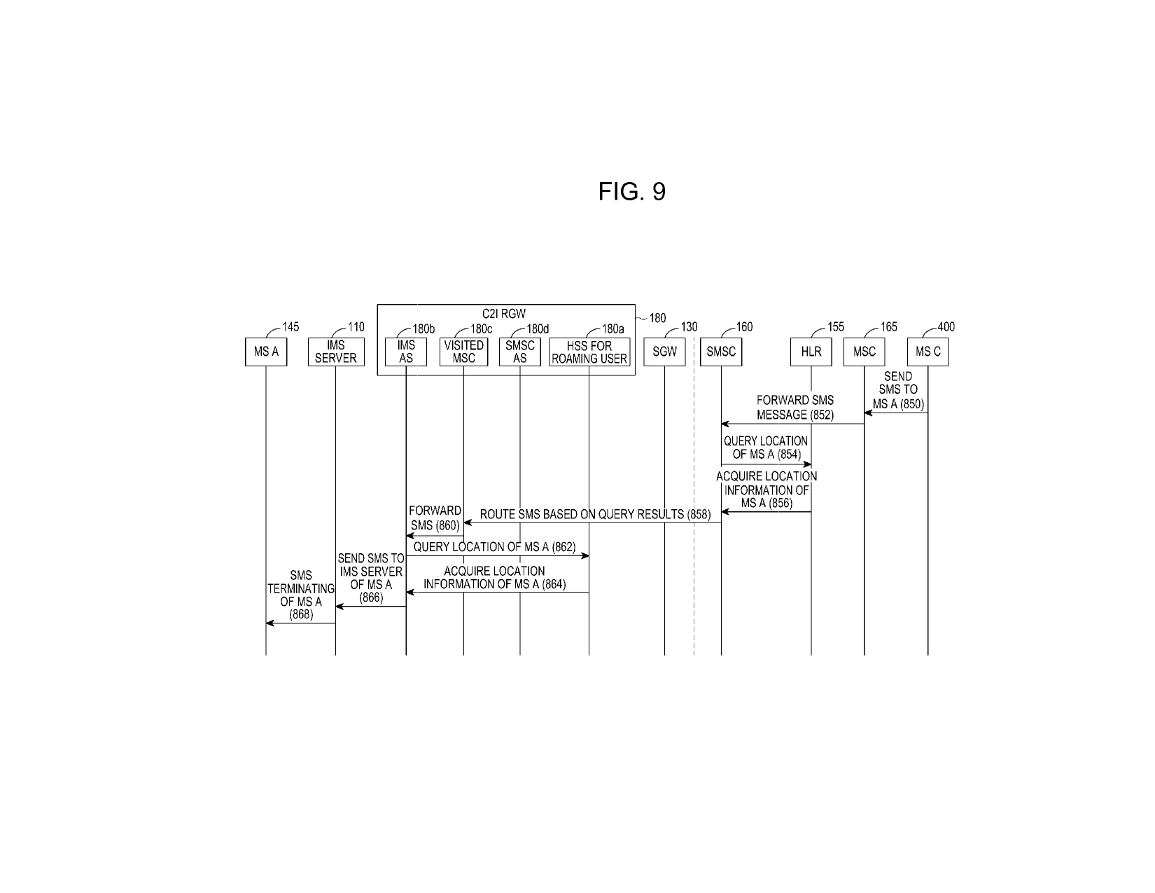

FIG. 9 illustrates a signal flow in a case where an SMS message terminates at an MS A having roamed from a CS network to an IMS network, according to another embodiment of the present invention. In the example of FIG. 9, the MS C 400 located in the CDMA-based CS network sends an SMS message to the MS A 145 having roamed to the IMS network.

In step 850, the MS C 400 sends the MSC 165 an SMS message to be transmitted to the MS A 145 having roamed to the IMS network. In step 852, the MSC 165 forwards the SMS message to the SMSC 160 of the MS A 145, a terminating MS. While the SMSC 160 in FIG. 8 is an SMSC 160 of the MS C 400, which is an originating MS, the SMSC 160 in FIG. 9 is an SMSC of the MS A 145, which is a terminating MS. In step 854, the SMSC 160 queries the HLR 155 located in the home network of the MS A 145, about location information of the MS A 145, since the MS A 145, a terminating MS, is a subscriber belonging to the CS network. In step 856, the SMSC 160 receives location information of the MS A 145 in reply to the query. Here, the HLR 155 is an HLR of the MS A 145, a terminating MS. In step 858, the SMSC 160 forwards the SMS message received in step 852 to the visited MSC 180c in the RGW 180 according to the location information of the MS A 145, acquired from the HLR 155 in step 856. In step 860, the visited MSC 180c forwards the SMS message to the IMS AS 180b. In step 862, the IMS AS 180b queries the HSS-for-roaming user 180a about location information of the MS A 145. The IMS AS 180b acquires location information of the MS A 145 from the HSS-for-roaming user 180a in step 864, and forwards the SMS message to the IMS server 110 in which the MS A 140 is registered, based on the acquired location information of the MS A 145 in step 866. In step 868, the IMS server 110 forwards the terminating SMS message to the MS A 145.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for providing a roaming service to a roaming Mobile Station (MS) having roamed from a Circuit Switched (CS) network to an Internet Protocol Multimedia Subsystem (IMS) network, comprising:
upon receiving an IMS registration request from the roaming MS having roamed to the IMS network, sending a request for registration and authentication for the roaming MS to a Home Location Register (HLR) in the CS network by a Roaming Gateway (RGW) performing communication between the IMS network and the CS network;
acquiring profile information about the roaming MS in the CS network from the HLR;
delivering the profile information of the roaming MS to an IMS server in the IMS network; and
delivering by the IMS server authentication results to the roaming MS.

2. The method of claim 1, wherein receiving the IMS registration request comprises:
selecting by the IMS server a Home Subscriber Server (HSS)-for-roaming user for handling registration of the roaming MS; and
sending an IMS registration request of the roaming MS to the selected HSS-for-roaming user.

3. The method of claim 2, wherein acquiring the profile information comprises:
sending by the RGW a request for CS registration and authentication for the roaming MS to an HLR in the CS network;
receiving authentication information about the roaming MS from the HLR in response to the request; and
performing authentication on the roaming MS.

4. The method of claim 3, further comprising mapping by the RGW authentication information of the roaming MS in the CS network to authentication information of the roaming MS in the IMS network.

5. The method of claim 4, further comprising:
if the roaming MS sends a call to a terminating MS located in the IMS network, searching by the IMS server a service profile for the roaming MS;
determining whether triggering information to a Telephony Application Server (TAS) is present in the service profile;
delivering service triggering information to the TAS in the presence of the triggering information to the TAS;
determining whether the terminating MS is a subscriber to the IMS network, after the TAS having received the service triggering information transmitted by the IMS server performs service processing on the roaming MS;
acquiring location information of the terminating MS from the HSS-for-roaming user if the terminating MS is a subscriber to the IMS network; and
forwarding the call sent by the roaming MS to the terminating MS according to the acquired location information.

6. The method of claim 5, further comprising:
determining by the TAS whether there is data required for service processing for the roaming MS; and
acquiring a service profile for the roaming MS from the HSS-for-roaming user in the absence of the data required for service processing for the roaming MS.

7. The method of claim 6, wherein the acquisition comprises:
querying by the IMS server the TAS about location information about the terminating MS; and
receiving location information about the terminating MS from the TAS in reply to the query.

8. The method of claim 4, further comprising:
if an MS in the CS network sends an outgoing call to the roaming MS, forwarding the outgoing call to the RGW according to a roaming number of the roaming MS by a Mobile Service Center (MSC) having received the outgoing call sent by the MS in the CS network;
forwarding by the RGW the outgoing call to the IMS server handling the roaming MS; and
forwarding by the IMS server the received outgoing call to the roaming MS.

9. The method of claim 8, further comprising:
querying by the MSC the HLR in the CS network about a location of the roaming MS at which the outgoing call is to terminate;
acquiring by the HLR the roaming number from a visited MSC in the RGW; and
transmitting the acquired roaming number to the MSC.

10. The method of claim 4, further comprising:
if the roaming MS sends a Short Message Service (SMS) message to an MS in the CS network, receiving by the IMS server the SMS message from the roaming MS;
searching a service profile of the roaming MS;
forwarding the SMS message to the RGW according to the search results;
upon identifying a location of the MS, forwarding by the RGW the SMS message to an MSC having an address of the MSC, which is location information of the MS; and
forwarding by the MSC the SMS message to the MS.

11. The method of claim 10, further comprising:
determining by the RGW whether an MS at which the SMS message is to terminate is a subscriber to the CS network;
if the MS is a subscriber to the CS network, querying the HLR about a location of the MS in the CS network; and
delivering by the HLR a location of the MS to the RGW.

12. The method of claim 4, further comprising:
if the roaming MS sends an SMS message to an MS in the CS network, receiving by the IMS server the SMS message from the roaming MS;
searching a service profile of the roaming MS;
forwarding the SMS message to the RGW according to the search results;
determining by the RGW whether the MS to receive the SMS message is a subscriber to the CS network;
sending the SMS message to a Short Message Service Center (SMSC) in the CS network if the MS is a subscriber to the CS network;
acquiring by the SMSC a location of the MS from the HLR;
upon identifying the location of the MS, forwarding the SMS message to an MSC having an address of the MSC, which is location information of the MS; and
forwarding by the MSC the SMS message to the MS.

13. The method of claim 4, further comprising:
if an MS in the CS network sends an SMS message to the roaming MS, receiving by the MSC the SMS message and sending the received SMS message to an SMSC of the MS;
querying by the SMSC the HLR about a location of the roaming MS;
acquiring a location of the roaming MS from the HLR;
sending the SMS message to the RGW based on the acquired location of the roaming MS;
sending by the RGW the SMS message to the IMS server managing the roaming MS, based on the location of the roaming MS; and
sending by the IMS server the SMS message to the roaming MS.

14. The method of claim 13, further comprising,
upon receipt of the SMS message, determining by the SMSC that the roaming MS is an MS which has belonged to the CS network before roaming to the IMS network.

15. The method of claim 4, further comprising:
if an MS in the CS network sends an SMS message to the roaming MS, receiving by the MSC the SMS message and sending the received SMS message to an SMSC of the roaming MS;
querying by the SMSC the HLR about a location of the roaming MS;
acquiring a location of the roaming MS from the HLR;
sending the SMS message to the RGW based on the acquired location of the roaming MS;
sending by the RGW the SMS message to an IMS server managing the roaming MS based on the location of the roaming MS; and
sending by the IMS server the SMS message to the roaming MS.

16. The method of claim 15, further comprising,
upon receipt of the SMS message, determining by the SMSC of the roaming MS that the roaming MS is an MS which has belonged to the CS network before roaming to the IMS network.

17. A system for providing a roaming service to a roaming Mobile Station (MS) having roamed from a Circuit Switched (CS) network to an Internet Protocol Multimedia Subsystem (IMS) network, comprising:
a Roaming Gateway (RGW) for performing communication between the IMS network and the CS network, sending a request for registration and authentication for the roaming MS to a Home Location Register (HLR) in the CS network upon receipt of an IMS registration request from the roaming MS having roamed to the IMS network, acquiring profile information for the roaming MS in the CS network from the HLR, and transmitting the acquired profile information of the roaming MS; and
an IMS server for receiving the profile information from the RGW, and delivering authentication results to the roaming MS.

18. The system of claim 17, wherein the IMS server selects a Home Subscriber Server (HSS)-for-roaming user for handling registration of the roaming MS, and sends an IMS registration request of the roaming MS to the selected HSS-for-roaming user.

19. The system of claim 18, wherein the RGW sends a request for CS registration and authentication for the roaming MS to the HLR in the CS network, receives authentication information for the roaming MS from the HLR in reply to the request, and performs authentication on the roaming MS.

20. The system of claim 19, wherein the RGW maps authentication information of the roaming MS in the CS network to authentication information of the roaming MS in the IMS network.

21. The system of claim 20, wherein if the roaming MS sends a call to a terminating MS located in the IMS network, the IMS server searches a service profile for the roaming MS, determines whether triggering information to a Telephony Application Server (TAS) providing an additional service is present in the service profile, transmits service triggering information to the TAS in the presence of the triggering information to the TAS, determines whether the terminating MS is a subscriber to the IMS network after the TAS performs service processing on the roaming MS upon receipt of the service triggering information, acquires location information of the terminating MS from the HSS-for-roaming user if the terminating MS is a subscriber to the IMS network, and forwards the call sent by the roaming MS to the terminating MS according to the acquired location information.

22. The system of claim 21, wherein the TAS determines whether there is data required for service processing for the roaming MS, and acquires a service profile for the roaming MS from the HSS-for-roaming user in the absence of the data required for service processing for the roaming MS.

23. The system of claim 22, wherein the IMS server queries the TAS about location information of the terminating MS, and receives location information of the terminating MS from the TAS in reply to the query.

24. The system of claim 20, further comprising a Mobile Service Center (MSC) for receiving, if an MS in the CS network sends an outgoing call to the roaming MS, the outgoing all sent by the MS in the CS network, forwarding the outgoing call to the RGW according to a roaming number of the roaming MS, and querying the HLR in the CS network about a location of the roaming MS at which the outgoing call is to terminate.

25. The system of claim 24, wherein the RGW forwards the outgoing call to the IMS server.

26. The system of claim 25, wherein the IMS server forwards the received outgoing call to the roaming MS.

27. The system of claim 26, wherein the HLR acquires the roaming number from the visited MSC in the RGW, and transmits the acquired roaming number to the MSC.

28. The system of claim 20, wherein if the roaming MS sends a Short Message Service (SMS) message to an MS in the CS network, the IMS server receives the SMS message from the roaming MS, searches a service profile of the roaming MS, and forwards the SMS message to the RGW according to the search results.

29. The system of claim 28, wherein upon identifying a location of the MS, the RGW forwards the SMS message to an MSC having an address of the MSC, which is location information of the MS, determines whether an MS at which the SMS message is to terminate is a subscriber to the CS network, and queries the HLR about a location of the MS in the CS network if the MS is a subscriber to the CS network.

30. The system of claim 29, wherein the MSC forwards the SMS message to the MS.

31. The system of claim 30, wherein the HLR delivers the location of MS to the RGW.

32. The system of claim 20, wherein if the roaming MS sends an SMS message to an MS in the CS network, the IMS server receives the SMS message from the roaming MS, searches a service profile of the roaming MS, and forwards the SMS message to the RGW according to the search results.

33. The system of claim 32, wherein the RGW determines whether the MS to receive the SMS message is a subscriber to the CS network, and forwards the SMS message to a Short Message Service Center (SMSC) in the CS network if the MS is a subscriber to the CS network.

34. The system of claim 33, wherein the SMSC acquires a location of the MS from the HLR, and upon identifying the location of the MS, forwards the SMS message to an MSC having an address of the MSC, which is location information of the MS.

35. The system of claim 34, wherein the MSC forwards the SMS message to the MS.

36. The system of claim 20, wherein if an MS in the CS network sends an SMS message to the roaming MS, the MSC receives the SMS message and forwards the received SMS message to an SMSC of the MS.

37. The system of claim 36, wherein upon receiving the SMS message, the SMSC queries the HLR about a location of the roaming MS, determining that the roaming MS is an MS which has belonged to the CS network before roaming to the IMS network, acquires a location of the roaming MS from the HLR, and sends the SMS message to the RGW based on the acquired location of the roaming MS.

38. The system of claim 37, wherein the RGW sends the SMS message to an IMS server managing the MS based on the location of the roaming MS.

39. The system of claim 38, wherein the IMS server sends the SMS message to the roaming MS.

40. The system of claim 20, wherein if an MS in the CS network sends an SMS message to the roaming MS, the MSC receives the SMS message and sends the received SMS message to an SMSC.

41. The system of claim 40, wherein upon receiving the SMS message, an SMSC of the roaming MS queries the HLR about a location of the roaming MS after determining that the roaming MS is an MS which has belonged to the CS network before roaming to the IMS network, acquires a location of the roaming MS from the HRL, and sends the SMS message to the RGW based on the acquired location of the roaming MS.

42. The system of claim 41, wherein the RGW sends the SMS message to the IMS server based on the location of the roaming MS.

43. The system of claim 42, wherein the IMS server sends the SMS message to the roaming MS.

44. An apparatus for providing a roaming service to a roaming Mobile Station (MS) having roamed from a Circuit Switched (CS) network to an Internet Protocol Multimedia Subsystem (IMS) network, comprising:
a Home Subscriber Server (HSS)-for-roaming user for sending a request to acquire information about the roaming MS in the CS network upon receiving an IMS registration request from the roaming MS having roamed to the IMS network, and performing authentication on the roaming MS upon acquiring information about the roaming MS in the CS network; and
a visited Mobile Service Center (MSC) for sending a request for registration and authentication for the roaming MS to a Home Location Register (HLR) in the CS network upon receiving from the HSS-for-roaming user a request to acquire information about the roaming MS in the CS network, acquiring service profile information for the roaming MS, and delivering the acquired service profile information to the HSS-for-roaming user.

45. The apparatus of claim 44, wherein the HSS-for-roaming user maps authentication information of the roaming MS in the CS network to authentication information of the roaming MS in the IMS network.

46. The apparatus of claim 45, wherein if the roaming MS sends a call to a terminating MS located in the IMS network, the HSS-for-roaming user provides the IMS server with service profile information for the roaming MS, when the IMS server in charge of call processing and service controlling for the roaming MS receives a request for service profile information including data required for service processing for the roaming MS.

47. The apparatus of claim 45, wherein if an MS in the CS network sends an outgoing call to the roaming MS, the visited MSC delivers a roaming number of the roaming MS to an MSC in the CS network, and forwards the outgoing call sent by the MS from the MSC to an IMS Application Server (AS).

48. The apparatus of claim 47, wherein upon receiving the outgoing call, the IMS AS acquires, from the HSS-for-roaming user, location information of the roaming MS at which the outgoing call is to terminate, and forwards the outgoing call to an IMS server providing a service to the roaming MS, based on the acquired location information.

49. The apparatus of claim 45, further comprising a Short Message Service Center (SMSC) AS for receiving, if the roaming MS sends a Short Message Service (SMS) message to an MS in the CS network, the SMS message sent by the roaming MS from the IMS server, acquiring, from the HLR, a location of a terminating MS to receive the SMS message, and forwarding the SMS message to an MSC corresponding to the acquired location of the terminating MS.

50. The apparatus of claim 45, further comprising an SMSC AS for receiving, if the roaming MS sends an SMS message to an MS in the CS network, the SMS message sent by the roaming MS from the IMS server, and forwarding the SMS message to an SMSC located in a home network of a terminating MS after determining that the terminating MS to receive the SMS message is a subscriber to the CS network.

51. The apparatus of claim 45, further comprising an IMS AS for receiving, if an originating MS in the CS network sends an SMS message to the roaming MS, the SMS message from the visited MSC, acquiring location information of the roaming MS from the HSS-for-roaming user, and forwarding the SMS message to the roaming MS based on the acquired location information;
wherein the SMS message received from the CS network is received from an SMSC of the originating MS.

52. The apparatus of claim 45, further comprising an IMS AS for receiving, if an originating MS in the CS network sends an SMS message to the roaming MS, the SMS message from the visited MSC, acquiring location information of the roaming MS from the HSS-for-roaming user, and forwarding the SMS message to the roaming MS based on the acquired location information;
wherein the SMS message received from the CS network is received from an SMSC located in a home network of the roaming MS.
